(19) United States
(12) Patent Application Publication
(10) Pub. No.: US 2011/0003728 A1
(43) Pub. Date: Jan. 6, 2011

(54) Cleaning composition

(76) Inventor: Carl R. Deaton, Valdosta, GA (US)

Correspondence Address: Langdale Vallotton, LLP, Post Office Box 1547, 1007 North Patterson Street, Valdosta, GA, 31603-1547, US

(21) Appl. No.: 12/459,662

(22) Filed: Jul. 6, 2009

(51) Int. Cl. C11D 3/20

(52) U.S. Cl. 510/190

(57) ABSTRACT

A rifle bore cleaning mixture of 2.4 by volume of Sweet's to 1 of Kroil to produce an approximate compound that is 70% by volume of Sweet's and 30% by volume of Kroil without combining any further additives with the mixture.

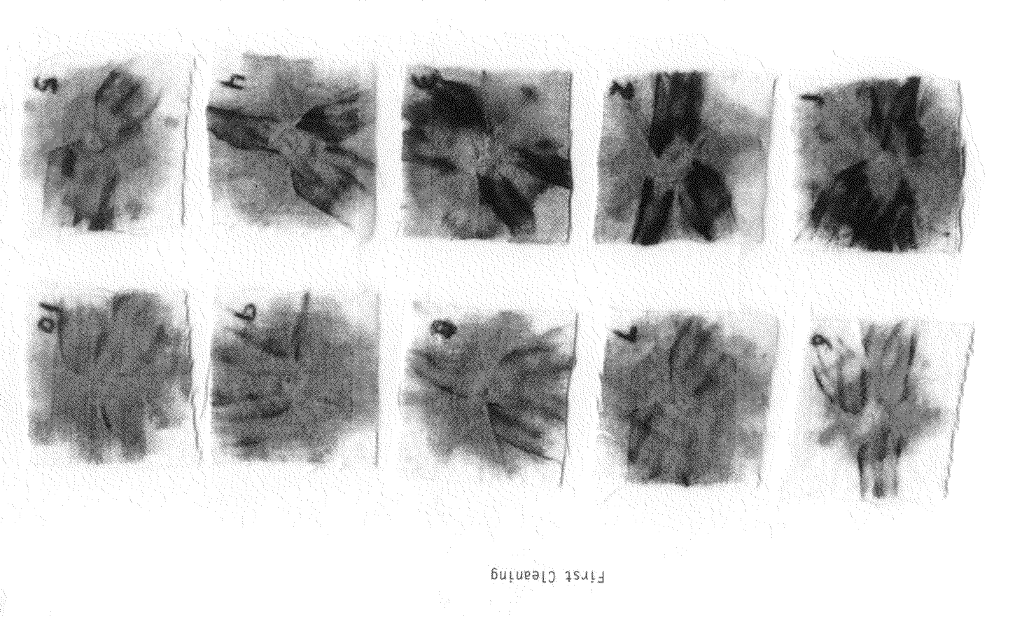

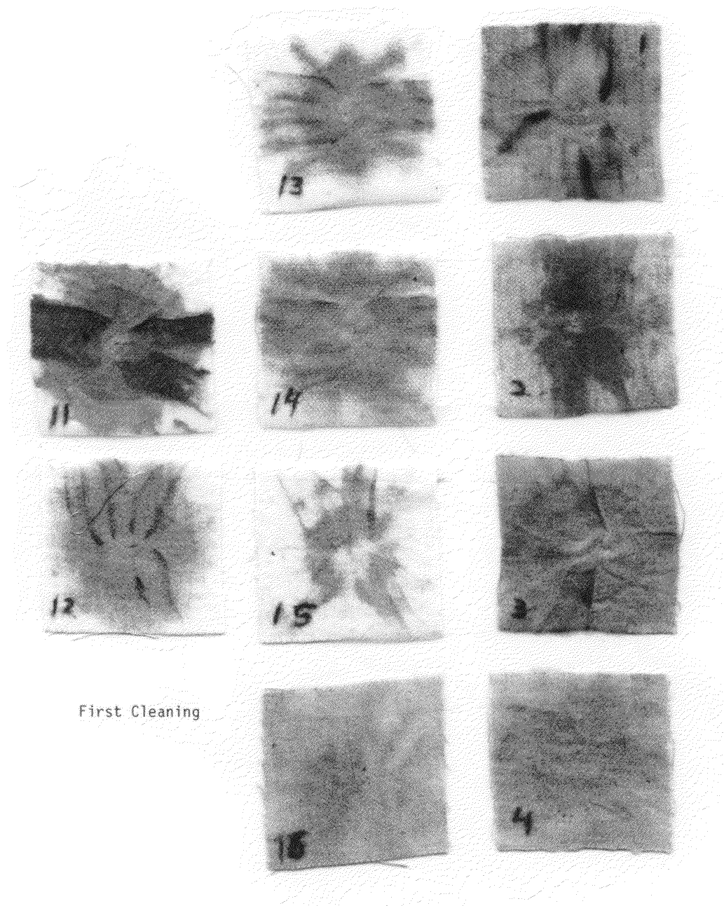

### CROSS-REFERENCES TO RELATED APPLICATIONS

None

### FEDERALLY SPONSORED RESEARCH OR DEVELOPMENT

None

### NAMES OF PARTNERS TO A JOINT RESEARCH AGREEMENT

None

### REFERENCE TO “SEQUENCE LISTING”

None

### BACKGROUND OF THE INVENTION

This invention relates to an improved compound for cleaning firearm bores and, more particularly, to a combination of 2.4 by volume of the fluid described in U.S. Pat. No. 5,565,039 to 1 of the Kano Laboratories, Inc. Aerokroil described in the Kano Laboratories, Inc. Jun. 7, 2005 “Safety Data Sheet,” and the like.

### BRIEF DESCRIPTION OF THE PRIOR ART

To clean the bore in a gun barrel is a problem that has confronted those who handle firearms as far back as the first application of black powder to guns and at all levels of use, from the recruit in basic training to the skilled competition marksman.

For example each time a rifle is fired the jacket of the projectile travelling through the rifled bore leaves a residue of metal (usually lead or copper) on the rifling. The “powder,” or propellant combustion products, moreover, that drive the projectile through the rifle bore also leave a residue within the bore. This combination of residual metal and burnt powder, or “fouling” can damage the bore by attacking the metal surface in a manner that causes “pitting” and other undesirable corrosive effects. These effects not only degrade the quality of the rifle barrel, but also decrease the firearm's accuracy.

Consequently, cotton flannel patches soaked with rifle bore cleaning compounds and placed on the end of a rifle bore cleaning rod or the like are run through a bore to remove the fouling. Ordinarily, these patches each are run once through the barrel and discarded. The patches, moreover, are run through the barrel until a clean patch emerges without any apparent fouling.

The cleaning compounds, however, are not fully effective because they fail to scour the fouling from hard-to-reach parts of the bore, e.g. fouling trapped within hairline cracks or fissures in the rifle barrel, fouling stuck in the angle formed where the sides of the raised rifling (the sides of the “lands”) intersect with the respective grooves that establish the maximum diameter of the rifle bore.

This failure to scour out all of the fouling is believed to be a consequence of the viscosity of these cleaning compounds in which the compound is too viscous, or “thick” to penetrate rifle bore fissures and the like in order to draw out or dissolve the fouling trapped therein.

One proposal for overcoming this problem that has been advanced suggests the use of a mixture by volume of half “Sweet's” bore cleaner (a product described in U.S. Pat. No. 5,565,039 granted on Oct. 15, 1996 to John H. Wagenknecht et al. for “Method For Dissolution Of Soft Metals From a Substrate Of A Harder Metal”) with AEROKROIL (a product produced by Kano Laboratories, Inc., 1000 E. Thompson Lane, Nashville, Tenn. 3721) “Kroil.” Further in this respect, a combination by volume of ⅔ Sweet's; ⅓ Kroil; and added “GM Top engine cleaner” also has been tried. Nevertheless, these mixtures have failed to provide a truly satisfactory vehicle for penetrating rifle barrel fissures and the like.

Accordingly, the need continues for a better bore cleaning compound.

### BRIEF DESCRIPTION OF THE INVENTION

A combination by volume of 6 ounces of Sweet's and 2.5 ounces of Kroil, that is, a mixture by volume percentage of approximately 70% Sweet's and 30% Kroil or 2.4 Sweet's to 1 Kroil has been found to produce remarkably superior results.

### BRIEF DESCRIPTION OF THE DRAWING

Photograph sheets 1/2 and 2/2 compare successive bore cleaning patches and the residues adhering to these patches using a prior art bore cleaning fluid to produce a superficially “clean” patch with a supplemental set of patches soaked in the bore cleaner that characterizes the invention to illustrate the quantity of fouling remaining in an apparently “clean” barrel that was removed through the practice of the invention.

### DETAILED DESCRIPTION OF THE PREFERRED EMBODIMENTS

The disadvantages of the prior art are largely overcome through practice of the invention. For example, it has been found that a mixture by volume of about 70% Sweet's and 30% Kroil, with no further additives produce the surprising result shown in photographs 1/2 and 2/2.

Numbered cotton flannel patches 1 through 15 illustrated in photograph 1/2 and 2/2 each were first soaked in Sweet's and run successively through the bore of a very dirty World War II .30 caliber Mauser rifle. Each of the patches 1 through 15, moreover, was used only once.

Sequential patch 16, shown in photograph 2/2 was soaked in Kroil and run once through the bore, patch 16 passing through the bore and emerging from the bore in an apparent “clean” condition.

Immediately thereafter, patch 1 in photograph 2/2 was soaked in a mixture by volume of 6 ounces of Sweet's and 2.5 ounces of Kroil (e.g. a ratio of 2.4 Sweet's to 1 of Kroil, or approximately by volume 70% Sweet's and 30% Kroil) and passed once through the bore to emerge therefrom in the condition shown in photograph 2/2. The quantity of fouling that adhered to patch 1 in photograph 2/2 was about equal to that which attached to patches 8 or 9 in photograph 1/2.

Note in this respect that the dark stripes on the patches as shown in the photos correspond to copper projectile jacketing and the lighter gray matter adhering to the patches is a powder residue, all of which have been removed from the bore.

Using the Sweet's/Kroil composition illustrative of the invention are results as exemplified through patches 1 through 4 in photo 2/2. Each of these four patches were soaked with the compound and subjected, sequentially once through the bore, the fourth patch (patch 4) emerging from the bore in a truly clean condition.

Unquestionably, treatment with fifteen patches soaked in Sweet's and one final Kroil—soaked patch failed to scour all of the fouling from the rifle bore. In contrast, applicant's composition was able to seep into fissures and other otherwise inaccessible parts of the rifle bore to dissolve or otherwise draw out a considerable quantity of fouling that escaped the action of other bore cleaning compositions.

An attempt to combine further additives with the 70% Sweet's/30% Kroil composition was not successful. For instance, 91% isopropyl alcohol was added to the 6 ounce Sweet's/2.5 ounces Kroil mixture and was found to be unsatisfactory. This mixture with alcohol, for example, separated after a few hours.

What is claimed is:

1. A rifle bore cleaning compound consisting of an approximate mixture of 2.4 by volume of Sweet's to 1 of Kroil.

2. A rifle bore cleaning compound consisting of an approximate mixture of 70% by volume of Sweet's to 30% by volume of Kroil.

3. A rifle bore cleaning compound consisting of an approximate mixture that is proportionate to 6 ounces by volume of Sweet's and 2.5 ounces by volume of Kroil.
